(19) United States
(12) Patent Application Publication
(10) Pub. No.: US 2011/0138585 A1
(43) Pub. Date: Jun. 16, 2011

(54) PHOTOVOLTAIC SUPPORT FRAME RAIL SYSTEM AND METHOD FOR USE WITH PHOTOVOLTAIC PANELS

(75) Inventors: Gerard J. Kmita, Allen Park, MI (US); Jeffrey M. Aftanas, Ortonville, MI (US); Donald L. Muñoz, Bloomfield Hills, MI (US)

(73) Assignee: JAC-Rack, Inc., Pontiac, MI (US)

(21) Appl. No.: 12/968,924

(22) Filed: Dec. 15, 2010

Related U.S. Application Data
(60) Provisional application No. 61/286,988, filed on Dec. 16, 2009.

(51) Int. Cl. F16B 2/06; E05B 65/00; H01R 4/48

(52) U.S. Cl. 24/522; 70/57; 439/834

(57) ABSTRACT

A lockable clamping system for use in securing photovoltaic (PV) panels to a frame rail component, wherein the frame rail component includes structure for engaging with a portion of the lockable clamping system. The lockable clamping system may have a clamp member having a body portion, with the body portion having a bore. A fastener may be operatively coupled to the clamp member and may extend through the bore in the clamp member generally perpendicular to the clamp member. The fastener may have a head portion having a key shaped recess, the key shaped recess configured to allow rotation of the fastener only via predetermined security key shaped to engage with the key shaped recess. The clamp member and the fastener may cooperatively operate to clamp adjacently positioned edges of a pair of PV panels to the frame rail component by engagement of a portion of the fastener with a portion of the frame rail component, while rotation of the clamp member is inhibited except through the use of the predetermined security key.

### CROSS-REFERENCE TO RELATED APPLICATIONS

This application claims the benefit of U.S. Provisional Application No. 61/286,988, filed on Dec. 16, 2009. The entire disclosure of the above application is incorporated herein by reference.

### FIELD

The present disclosure relates to systems and methods for use in mounting and supporting photovoltaic panels on roofs and other support structures, and more particularly to support frame rail systems and methods for supporting photovoltaic panels on commercial and residential structures, as well as on other forms of support surfaces.

### BACKGROUND

This section provides background information related to the present disclosure which is not necessarily prior art. The use of photovoltaic (“PV”) panels is becoming increasingly popular as a means for providing a supplemental source of electric power in both commercial and residential applications. Such systems may often involve dozens, hundreds or even thousands of independent PV panels. The overall cost of implementing a PV panel system is heavily influenced by the costs associated with installing the PV panels on a roof, wall or other support structure. Presently, frame rails are typically used to support the PV panels above a roof, a wall, or some other support structure. The frame rails have typically been formed with one or more grooves to receive independent fastening brackets. Typically the grooves have been arranged on the frame rails in a specific configuration that requires the frame rails to be laid out such that the external brackets can be attached to the frame rails. This requires the assembler to carefully arrange the frame rails so that no one or more of the rails is orientated incorrectly.

Still another consideration with present day PV panels is the need to establish a ground path between the frame of each PV panel and the frame rail on which it is being installed. Various means have been developed for this but all have some drawbacks, either in terms or performance or in terms of the time and complexity required to install the grounding implement when assembling the PV panels to their support frame rails.

Presently there is also a concern with theft of PV panels. As the PV panels can be expensive, the theft concern has taken on greater interest in recent years. Nevertheless, there has not been a satisfactory means for inhibiting the theft of PV panels after they are installed on a structure, short of installing surveillance equipment where the PV panels are in use, or taking other measures that can be costly, time consuming to install or implement, and of limited effectiveness.

### SUMMARY

In one aspect the present disclosure relates to a lockable clamping system for use in securing photovoltaic (PV) panels to a frame rail component, wherein the frame rail component includes structure for engaging with a portion of the lockable clamping system. The lockable clamping system may comprise a clamp member having a body portion, with the body portion having a bore. A fastener may be operatively coupled to the clamp member and may extend through the bore in the clamp member generally perpendicular to the clamp member. The fastener may include a head portion having a key shaped recess, the key shaped recess configured to allow rotation of the fastener only via predetermined security key shaped to engage with the key shaped recess. The clamp member and the fastener may cooperatively operate to clamp adjacently positioned edges of a pair of PV panels to the frame rail component by engagement of a portion of the fastener with a portion of the frame rail component, while rotation of the clamp member is inhibited except through the use of the predetermined security key.

In still another aspect the present disclosure relates to a lockable clamping system for use in securing photovoltaic (PV) panels to a frame rail component. The system may comprise a clamp member having a body portion with the body portion having a bore. A barrel nut may be secured to the clamp member and may have a key shaped recess at one end thereof. The key shaped recess may be adapted to allow rotation of the barrel nut only through the use of a predetermined security key. A T-lug fastener element having a T-member and a threaded shaft is provided. The T-member is adapted to engage the frame rail component within a channel of the frame rail component, and the threaded shaft is adapted to be threadably engaged within internal threads of the barrel nut. The barrel nut, the clamp member and the T-lug fastener cooperatively operate to clamp adjacently positioned edges of a pair of PV panels to the frame rail component and to prevent unclamping of the PV panels from the frame rail component except when the barrel nut is loosened through the use of the predetermined security key.

In still another aspect a lockable clamping system is provided for use in securing photovoltaic (PV) panels to a frame rail component, where the frame rail component has spaced apart, opposing serrated wall portions. The system may comprise a clamp member having a body portion, with the body portion having a bore. A threaded fastener extends through the bore in the body portion of the clamp member and is secured to the body portion to enable rotational movement relative to the body portion. The threaded fastener includes an enlarged head portion having a key shaped recess at one end thereof. The key shaped recess allows rotation of the threaded fastener only through the use of a predetermined security key that is shaped to engage the key shaped recess. Threads of the threaded fastener are adapted to engage the serrations of the opposing serrated walls of the frame rail component as the threaded fastener is inserted between the serrated wall portions. The threaded fastener cannot thereafter be withdrawn from the frame rail component except when rotating the threaded fastener through use of the predetermined security key.

### DRAWINGS

The drawings described herein are for illustrative purposes only of selected embodiments and not all possible implementations, and are not intended to limit the scope of the present disclosure.

FIG. 1 is a perspective view of a corner portion of a PV panel with a PV frame member in accordance with one embodiment of the present disclosure, together with a slide on grounding clip that creates a ground path between the PV frame member and a support frame rail on which the PV panel is being supported;

FIG. 2 is a perspective view of just the grounding clip shown in FIG. 1;

FIG. 3 is an end view of just the grounding clip;

FIG. 4 is a cross sectional end view of the frame member with the grounding clip secured thereto, and being supported on a support rail;

FIG. 5 is a perspective view of a frame rail in accordance with another aspect of the present disclosure, and also illustrating a bracket that may be used with the frame rail to secure the frame rail to a roof or other support surface;

FIG. 6 is an end view of a locking frame rail system in accordance with another aspect of the present disclosure;

FIG. 7 is a plan view of a C-clip used with the system of FIG. 6;

FIG. 8 is a perspective view of the clamp member and the barrel nut secured thereto;

FIG. 9 is a perspective view of a grounding clip being implemented with a T-lug for use in the system of FIG. 6; and

FIG. 10 is a perspective view of another form of assembly for locking a clamping member to a frame rail, where the frame rail has a channel having serrated opposing surfaces that threadably engage the threaded shaft.

Corresponding reference numerals indicate corresponding parts throughout the several views of the drawings.

### DETAILED DESCRIPTION

Example embodiments will now be described more fully with reference to the accompanying drawings.

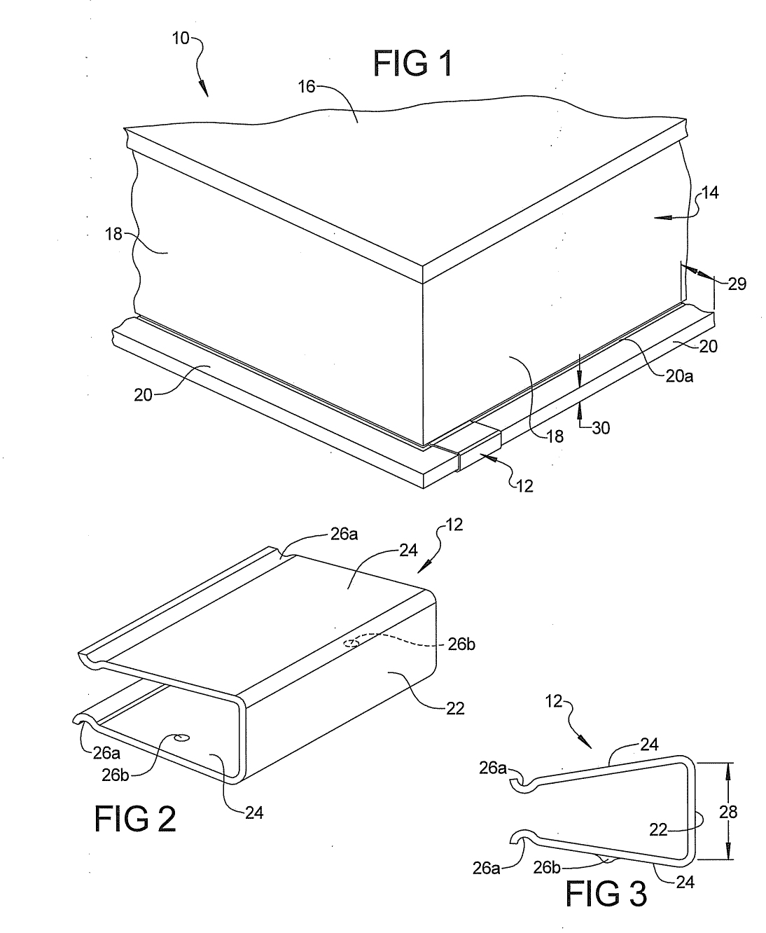

Referring to FIG. 1, there is shown a photovoltaic (“PV”) panel 10 and a grounding clip 12 in accordance with one aspect of the present disclosure. The PV panel 10 includes a PV frame member 14 and a PV element 16 secured to the frame member 14 in any conventional manner. The PV frame member 14 includes a wall portion 18 and a flange portion 20. The flange portion 20 may have oppositely facing semicircular grooves 20a (only one being visible in FIG. 1) running along its full length or formed only at one or more designated areas of the frame member 14. The flange portion 20 may be integrally formed with the wall portion 18 or it may be mechanically and electrically coupled via suitable conductive fasteners. However, it is believed that a preferred manner of construction for the frame member 14 will be extruding it from a suitable material, for example, but not limited to, aluminum, as a single piece component. Typically four sections of the frame member 14 will be secured to form a square or rectangular shape, although other shapes are certainly possible that employ more or less than four sections of frame member 14. Typically the adjoining corners of the frame members 14 will be miter cut before being fastened together with suitable, conventional corner fastening elements.

The grounding clip 12 is constructed of dimensions enabling it to be quickly and easily slid onto the flange portion 20 of the frame member 14 without the need for any external tools. The grounding clip 12 may be made from any electrically conductive material that is resistant to the elements, for example stainless steel.

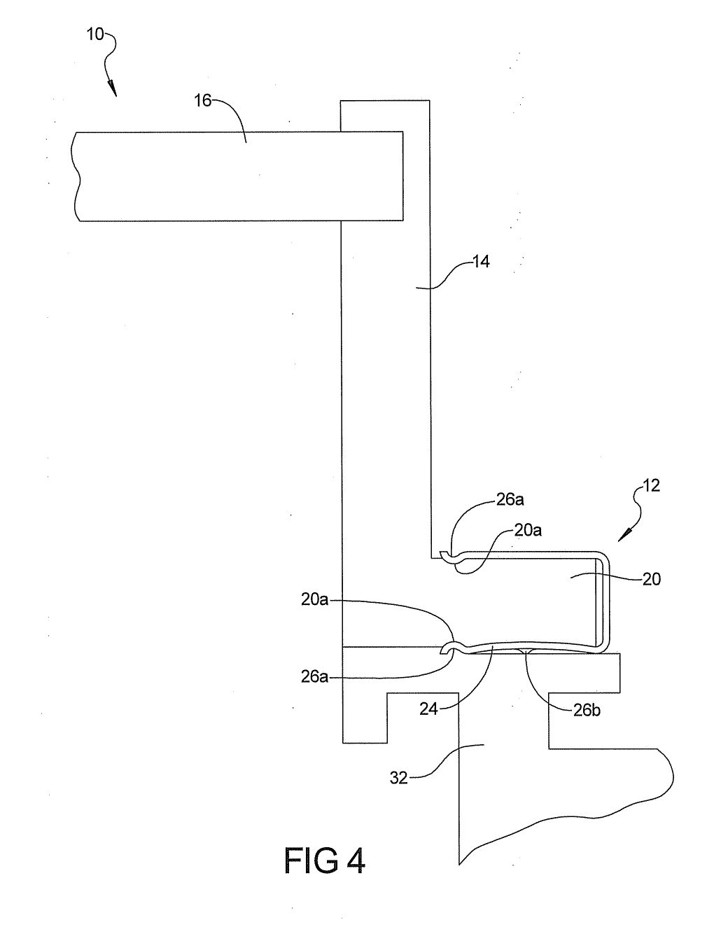

With reference to FIGS. 2 and 3, the grounding clip 12 is shown in even greater detail. The grounding clip 12 includes a base portion 22 and two arm portions 24 formed to converge slightly towards each other. Each arm portion 24 may also include a semicircular shaped distal edge portion 26a, and one of the arm portions may include one or more barbs or tooth portions 26b projecting outwardly therefrom. The height of the base portion 22, designated by arrow 28 in FIG. 3, is preferably just slightly larger than the thickness of the flange portion 20 of the frame member 14, as indicated by arrow 30 in FIG. 1. The arm portions 24 are further approximately the same length as the flange portion 20, as indicated by arrow 29 in FIG. 1. In this manner when the grounding clip 12 is pushed onto the flange portion 20, the arm portions 24 expand slightly, aided by the semi-circular shaped distal edge portions 26a as they contact the corner edges of the flange portion 20. Once fully installed, as shown in FIG. 4, the semicircular shaped distal edge portions 26a engage with the semicircular grooves 20a on the flange portion 20 to even further help retain the grounding clip 12 to the flange portion. The squeezing action of the arm portions 24 helps to retain the grounding clip 12 secured to the flange portion 20, while the teeth 26b dig or “bite” into the surface of the support frame rail 32 to make excellent electrical contact with the flange portion 20 and the support frame rail 32. It will be appreciated that while the semicircular distal edge portions 26a and the semicircular grooves 20a help to retain the grounding clip 12 to the flange portion 20, that they are not absolutely essential to the operation of the grounding clip 12. For example, the arm portions 24 could be formed with a curvature at their distal ends which is sufficient to help spread apart the arm portions during sliding assembly of the grounding clip 12 on to the flange portion 20.

By forming the flange portion 20 integrally with the wall portion 18, a conductive portion of the frame member 14 is provided that is readily accessible to the installer. This enables the grounding clips 12 to be quickly and easily installed on the flange portion 20 before the entire PV panel 10 is installed on one or more external frame rails. Thus, there is no need to position one or more conventional grounding washers between the frame member 14 and the frame rail, and assembly of the PV panels 10 to the frame rails can be done on an even more expedited basis.

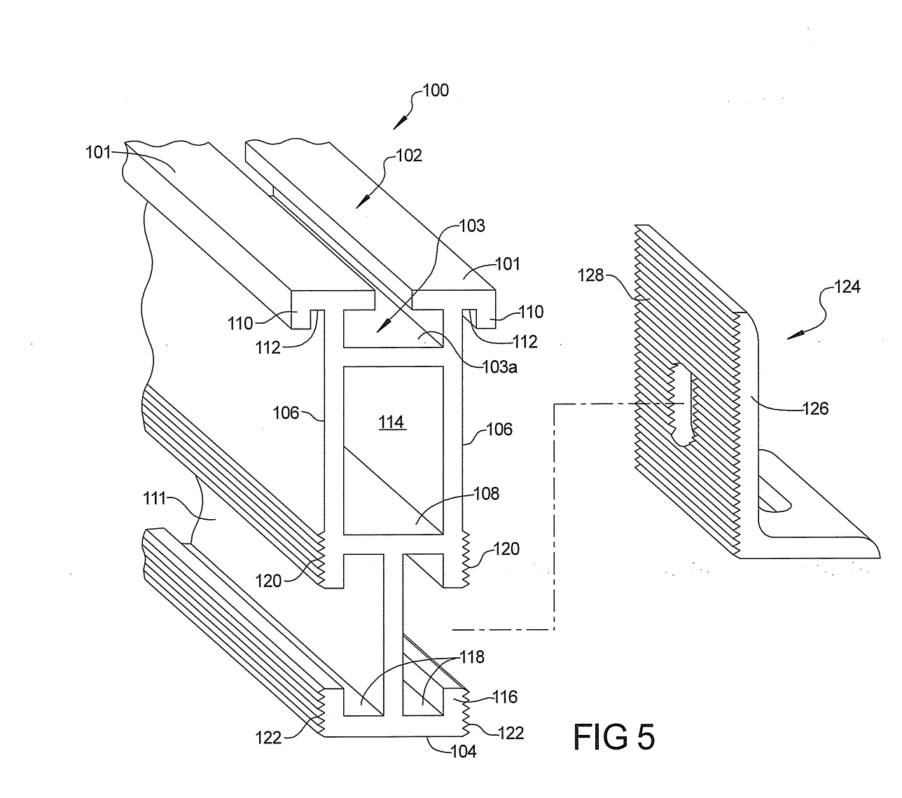

Referring now to FIG. 5, there is shown an embodiment of a frame rail 100 in accordance with another aspect of the present disclosure. A principal feature of the frame rail 100 is that it is symmetrical in construction. The advantage that this provides is that the frame rail 100 can be oriented in either of two orientations 180 degrees from one another and still be used to secure mounting brackets and other components to the frame rail 100 that are needed to secure a PV panel, such as PV panel 10, thereto. Thus, there is less of a need for the installer to be mindful of the exact orientation of the frame rail 100 when securing multiple sections of the frame rail 100 to a roof or other support structure.

The frame rail 100 includes two inwardly facing ledges 101 forming a top wall 102 and a channel 103. A bottom wall 104, sidewalls 106 and an intermediate wall 108 are also included. The top wall 102 has a pair of flanges 110 that define a first pair of co-linear channels 112. Portions 103a, 106 and 108 cooperate to define a hollow area 114 that may extend the entire length of the frame rail 100. This provides a weight and cost savings. Extending from the intermediate wall 108 is a central wall 111 that connects with the bottom wall 104. The bottom wall 104 has a pair of flanges 116 that define channels 118. The sidewalls 106 each have a plurality of linear grooves or serrations 120 integrally formed thereon. Similarly, flanges 116 each include linear grooves or serrations 122.

Referring to further to FIG. 5, a mounting bracket 124 is shown that may include a wall portion 126 having linear grooves or serrations 128 with a spacing preferably the same as the serrations 120. The serrations 120, 122 and the serrations 128 allow the installer to align and hold the mounting bracket 124 more easily and accurately before drilling a hole in one of the sidewalls 106 to fasten the bracket 124 to the frame rail 100 with an external fastener.

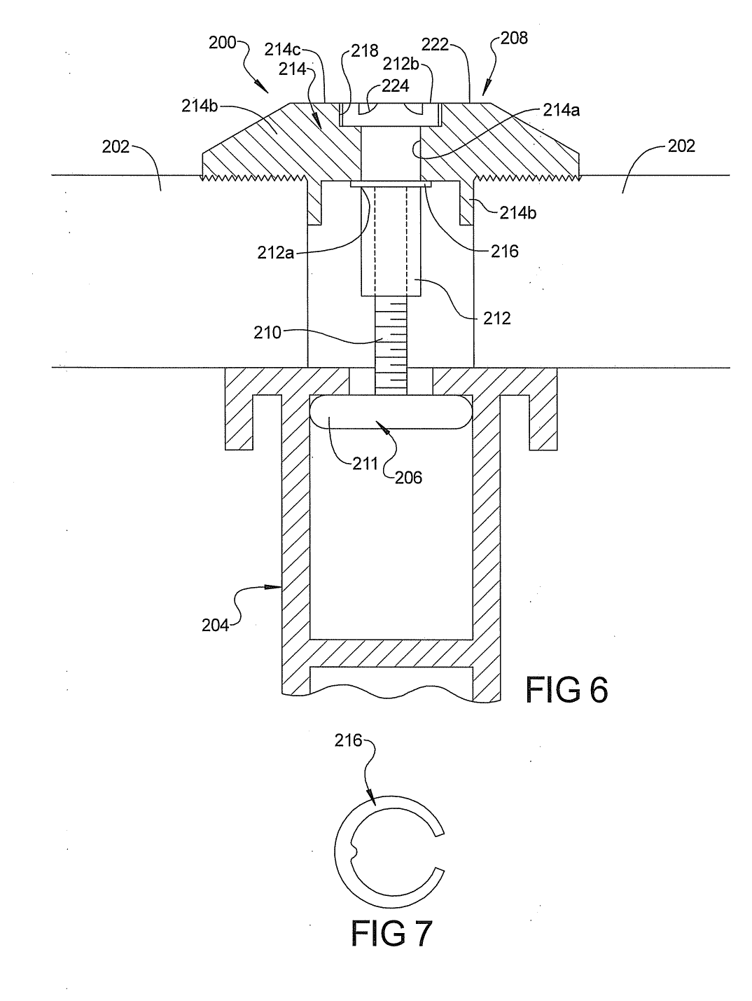

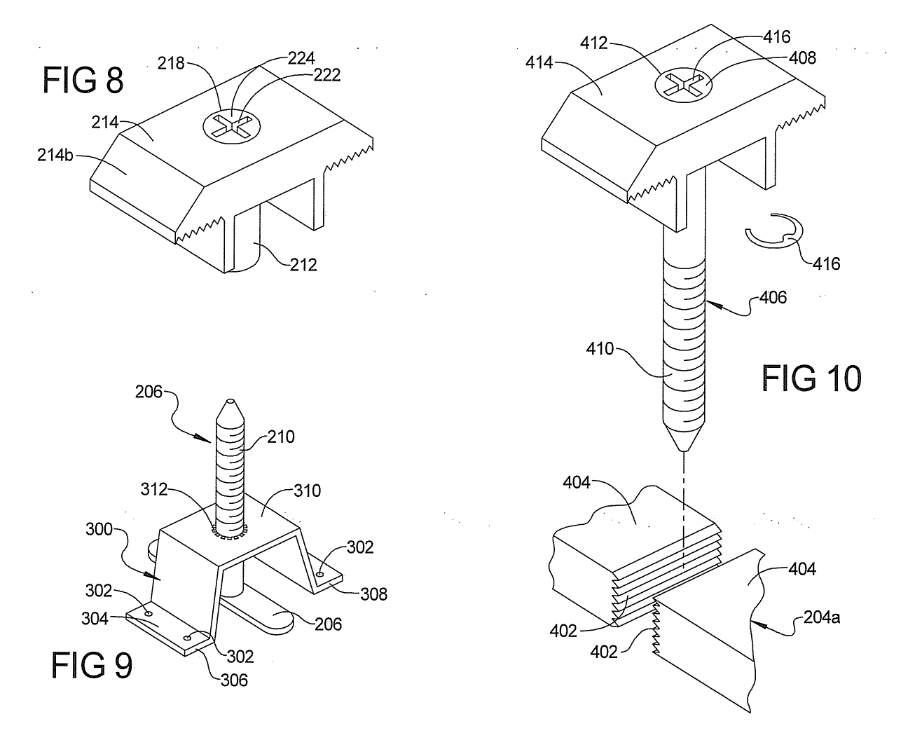

Referring now to FIG. 6, there is shown a locking frame rail system 200 in accordance with another aspect of the present disclosure for lockably securing a pair of PV panels 202 to a frame rail 204. The system 200 generally includes the frame rail 204, a T-lug fastening element 206, and a lockable clamping element 208. The T-lug fastening element 206 includes a threaded end portion 210 extending from a T-member 211, and the lockable clamping element 208 includes a barrel nut 212 that extends through a bore 214a in a clamp body 214b of the member 214. The barrel nut 212 is internally threaded, as indicated by dashed lines 212b, and is secured to the clamp member 214 by a C-clip 216. The C-clip 216 is also shown in FIG. 7 and the clamp member 214 is also shown in greater detail in FIG. 8. The C-clip 216 rests in a groove 212a on the barrel nut 212 outer surface adjacent a lower surface of the clamp member 214. The C-clip 216 thus prevents the barrel nut 212 from being pulled upwardly in the drawing of FIG. 6 out of the clamp member 214. Depending legs 214b extend from a body portion 214a of the clamp member 214 and serve to set a spacing between the edges of frame rails 202 that are being secured by the system 200.

Referring to FIGS. 6 and 8, the clamp member 214 includes a recess 218 formed concentrically with the bore 214a. The barrel nut 212 also includes a flanged upper end 222 that is dimensioned similar, but just slightly smaller than, the diameter of the recess 218 so that an upper surface 212b of the barrel nut 212 sits approximately flush with an upper surface 214c of the clamp body 214a. The upper surface 212b of the barrel nut 212 also includes a key shaped recess 224 that is shaped to fit a security key (not shown) that is used to tighten the barrel nut 212 to the threaded shaft 210 of the T-lug fastening element 206. The key shaped recess 224 may take any suitable form, so long as it is not able to be engaged securely with a conventional screwdriver or other like implement. One particularly well suited locking fastener that may be readily adapted for use with the barrel nut 212 is the MORTICO® spiral drive system available from Phillips Screw Company of Wakefield, Mass. However, it will be appreciated that virtually any type of security key shape that prevents the use of conventional, tools such as screwdrivers, TORX® bit drivers, etc., may potentially be employed. Once the T-lug fastening element 206 is tightened onto the barrel nut 212, the clamp member 214 will hold the PV panels 202 securely to the frame rail 204, and the clamp member 214 cannot be loosened without the appropriately shaped key to engage the key shaped recess 224 in the barrel nut 212.

Referring to FIG. 9, it can be seen that a grounding clip 300 may also be employed with the T-lug fastening element 206. The grounding clip 300 may have a generally U-shape with teeth or tangs 302 on both an upper surface 304 and a lower surface 306 of each flange 308. A babe portion 310 may have a serrated opening 312 that retains the T-lug fastening element 206. The grounding clip 300 may be made of stainless steel or any other suitable material, and may be interposed between the frame members 202a of the PV panels 202 and the ledges 204a of the frame rail 204. The grounding clip 300 provides an electrically conductive path between the frame members of the PV panels 202 and the frame rail 204 supporting the PV panels.

Referring to FIG. 10, a different form of clamp assembly 40b is shown that may be used in place of the clamp member 214 and T-lug fastening element 206. The clamp assembly 400 may be used if a frame rail 204a includes an interior channel having serrations 402 along inwardly projecting ledges 404. The clamp assembly 400 may include a threaded fastener 406 having an enlarged head portion 408 and a threaded shaft 410. The enlarged head portion 408 may rest within a recess 412 in a clamp member 414. A C-clip 416 may be secured in a groove (not visible in FIG. 10) in the threaded fastener 406 as described above for the barrel nut 212, so that the threaded fastener 406 cannot be removed from the clamp member 414. A security key recess 416 prevents conventional tools from turning the head portion 408. The threaded shaft 410 engages the serrations 404 in the frame rail 204 to clamp the PV panels 202 to the frame rail 204 without the need for a T-lug element to be positioned within a channel of the frame rail 204a.

The various systems and embodiments described above all help to significantly expedite the installation of PV panels. The disclosed embodiments also add a significant degree of security to a PV installation that prevents the removal of the PV panels once they are installed, unless the proper security tool (i.e., key) is used.

The foregoing description of the various embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A lockable clamping system for use in securing photovoltaic (PV) panels to a frame rail component, wherein the frame rail component includes structure for engaging with a portion of the lockable clamping system, the lockable clamping system comprising:
a clamp member having a body portion, the body portion having a bore;
a fastener operatively coupled to the clamp member and extending through the bore in the clamp member generally perpendicular to the clamp member;
the fastener including a head portion having a key shaped recess, the key shaped recess configured to allow rotation of the fastener only via predetermined security key shaped to engage with the key shaped recess; and
the clamp member and the fastener cooperatively operating to clamp adjacently positioned edges of a pair of PV panels to the frame rail component by engagement of a portion of the fastener with a portion of the frame rail component, while rotation of the clamp member is inhibited except through the use of the predetermined security key.

2. The system of claim 1, wherein the fastener includes a threaded portion that engages with a portion of the frame rail component as the fastener is inserted into the frame rail component.

3. The system of claim 1, further comprising a barrel nut operatively coupled to the clamp member, the barrel nut including an internal threaded bore; and
the fastener including a threaded portion that engages with the internal threaded bore and wherein the fastener includes a T-shaped portion for engaging with the portion of the frame rail component.

4. The system of claim 1, wherein the clamp member includes a recess for housing a portion of the fastener.

5. The system of claim 1, further comprising a metallic grounding clip having a hole through which a portion of the fastener extends, the metallic grounding clip adapted to be captured between the edges of the PV panels and a surface of the frame rail component to provide an electrical ground path.

6. A lockable clamping system for use in securing photovoltaic (PV) panels to a frame rail component, the system comprising:
a clamp member having a body portion, the body portion having a bore;
a barrel nut secured to the clamp member and having a key shaped recess at one end thereof, the key shaped recess adapted to allow rotation of the barrel nut only through the use of a predetermined security key;
a T-lug fastener element having a T-member and a threaded shaft, the T-member adapted to engage the frame rail component within a channel of the frame rail component, and the threaded shaft adapted to be threadably engaged within internal threads of the barrel nut, and
the barrel nut, the clamp member and the T-lug fastener cooperatively operating to clamp adjacently positioned edges of a pair of PV panels to the frame rail component and to prevent unclamping of the PV panels from the frame rail component except when the barrel nut is loosened through the use of the predetermined security key.

7. The system of claim 6, wherein the body portion of the clamp member includes a pair of depending arms spaced apart a predetermined distance to maintain a desired spacing between the adjacently positioned edges of the PV panels.

8. The system of claim 6, wherein the main body portion of the clamp member includes a recess, and wherein a portion of the key shaped recess portion of the barrel nut fits within the recess.

9. The system of claim 6, wherein the barrel nut includes a groove on an exterior surface thereof, and wherein the barrel nut is secured to the clamp member by a C-clip disposed within the groove.

10. The system of claim 6, further including a metallic grounding clip having an opening adapted to receive the threaded shaft portion of the T-lug fastener and to be interposed between the edges of the PV panels and a surface of the frame rail component.

11. The system of claim 10, wherein the metallic grounding clip comprises a U-shape.

12. The system of claim 11, wherein the metallic grounding clip further comprises a plurality of teeth.

13. A lockable clamping system for use in securing photovoltaic (PV) panels to a frame rail component having spaced apart, opposing serrated wall portions, the system comprising:
a clamp member having a body portion, the body portion having a bore;
a threaded fastener extending through the bore in the body portion of the clamp member and being secured to the body portion to enable rotational movement relative to the body portion, the threaded fastener including an enlarged head portion having a key shaped recess at one end thereof, the key shaped recess adapted to allow rotation of the threaded fastener only through the use of a predetermined security key that is shaped to engage the key shaped recess; and
wherein threads of the threaded fastener are adapted to engage the serrations of the opposing serrated walls of the frame rail component to prevent withdrawal of the threaded fastener from the frame rail component except when rotating the threaded fastener through use of the predetermined security key.

14. The system of claim 13, further comprising a metallic grounding clip having a hole for receiving a portion of the threaded fastener therethrough, the metallic grounding clip adapted to be captured between a surface of the frame rail component and edge portions of the PV panels.

15. The system of claim 14, wherein the metallic grounding clip comprises a U-shaped component.

16. The system of claim 15, wherein the metallic grounding clip further comprises a plurality of teeth.

17. The system of claim 13, wherein the body portion includes a recess, and wherein a portion of the threaded fastener rests within the recess.

18. The system of claim 17, wherein the enlarged head portion is substantially flush with a surface of the main body.

19. The system of claim 13, further comprising, a pair of depending arms projecting from the body portion of the clamp member, the depending arms being spaced apart a predetermined distance to maintain a desired spacing between the adjacently positioned edges of the PV panels when the PV panels are clamped adjacent one another using the clamp member.

20. The system of claim 13, wherein the threaded fastener includes a groove on an outer surface thereof, and further comprising a C-clip for engaging the groove and securing the threaded fastener to the clamp member while allowing rotational movement of the threaded fastener by use of the predetermined security key.
